(19) United States
(12) Patent Application Publication
(10) Pub. No.: US 2014/0098002 A1
(43) Pub. Date: Apr. 10, 2014

(54) ANTENNA MODULE

(71) Applicant: UNIVERSAL SCIENTIFIC INDUSTRIAL (SHANGHAI) CO., LTD., Shanghai City (CN)

(72) Inventors: Cheng-Ta LI, Nantou City (TW); Jui-Chih CHIEN, Chiayi County (TW); Hung-Wei CHIU, Taichung City (TW); UNIVERSAL GLOBAL SCIENTIFIC INDUSTRIAL CO., LTD., Caotun Township (TW)

(73) Assignees: UNIVERSAL GLOBAL SCIENTIFIC INDUSTRIAL CO., LTD., Caotun Township (TW); UNIVERSAL SCIENTIFIC INDUSTRIAL (SHANGHAI) CO., LTD., Caotun Township (TW)

(21) Appl. No.: 13/777,619

(22) Filed: Feb. 26, 2013

(30) Foreign Application Priority Data
Oct. 8, 2012 (TW) 101137152

(51) Int. Cl. H01Q 1/12

(52) U.S. Cl. CPC H01Q 1/1207
USPC 343/878

(57) ABSTRACT

An antenna module includes a printed circuit board, multiple conductive clamps bonded to the printed circuit board, each conductive clamp having elastic clamping arms at two opposite lateral sides thereof, and an antenna inserted in between the clamping arms of each conductive clamp and secured and electrically conducted to the printed circuit board by the conductive clamps for signal feed-in and grounding.

### BACKGROUND OF THE INVENTION

1. Field of the Invention

The present invention relates to an antenna for handheld electronic device and more particularly, to an antenna module, which uses conductive clamps to secure an antenna to a printed circuit board and work as a signal feed-in point and/or grounding point of the antenna.

2. Description of the Related Art

A handheld electronic device, for example, a portable barcode scanner has an antenna mounted in the housing thereof for receiving and transmitting wireless signals. Conventionally, an antenna for portable barcode scanner is bonded to a printed circuit board with multiple contact type metal spring plates or conductve sponge components by means of SMT (surface mount technology). The antenna is kept in contact with the metal spring plates or conductive sponge components, thereby electrically conducted to the printed circuit board for signal feed-in and grounding.

However, the aforesaid metal spring plates may be permanently deformed after a long use, resulting in contact failure between the printed circuit board and the antenna. Further, conductive sponge components may be peeled off from the printed circuit board easily, leading to contact failure between the printed circuit board and the antenna. Further, screw holes or female screws must be provided at the printed circuit board so that the antenna can be affixed to the printed circuit board with screws. The arrangement of these screw holes or female screws occupies much printed circuit board space and limits the design of the circuit layout of the printed circuit board. Further, when making the screw holes on the printed circuit board or mounting the female screws at the printed circuit board, the printed circuit board may causing the printed circuit board broken easily and increasing the cost. The use of the contact type spring plates or conducting sponge components cannot provide excellent conductivity and positioning effect to the antenna at the same time.

### SUMMARY OF THE INVENTION

The present invention has been accomplished under the circumstances in view. It is the main object of the present invention to provide an antenna module, which facilitates installation and avoids printed circuit board breaking due to installation of female screws or screw holes.

To achieve this and other objects of the present invention, an antenna module comprises a printed circuit board, a plurality of conductive clamps, and an antenna. Each conductive clamp comprises at least one base portion bonded to the printed circuit board, and at least two elastic clamping arms extended from two opposite sides of each base portion in a direction away from the printed circuit board. The antenna is detachably inserted in between the elastic clamping arms at the two opposite lateral sides of each base portion of each conductive clamp. Thus, the conductive clamps can secure the antenna positively in position and electrically conduct the antenna to the printed circuit board. This installation procedure is simple and convenient, avoiding the problem of printed circuit board breaking.

Further, the antenna can be shaped like a cap member, or made in the form of a flat plate. If the antenna is shaped like a cap member, the peripheral wall of the antenna can be directly inserted in between the elastic clamping arms at the two opposite lateral sides of each base portion of each conductive clamp. If the antenna is made in the form of a flat plate, the antenna is fixedly mounted at one side of a support member and then inserted in between the elastic clamping arms at the two opposite lateral sides of each base portion of each conductive clamp.

Further, the number of the conductive clamps can be 2, or more than 2. The conductive clamps can be arranged on the printed circuit board around the antenna to secure the antenna from displacement relative to the printed circuit board. Alternatively, the conductive clamps can be positioned in an array arrangement on the printed circuit board. Subject to this array design, different sizes of antennas can be selectively mounted at the printed circuit board, or, two antennas can be simultaneously mounted at the printed circuit board.

Other and further benefits, advantages and features of the present invention will be understood by reference to the following specification in conjunction with the accompanying drawings, in which like reference characters denote like elements of structure.

### BRIEF DESCRIPTION OF THE DRAWINGS

FIG. 1 is an elevational view of an antenna module in accordance with the first embodiment of the present invention.

FIG. 2 is an exploded view of the antenna module in accordance with the first embodiment of the present invention.

FIG. 3 is an elevational view of a conductive clamp for antenna module in accordance with the first embodiment of the present invention.

FIG. 4 is a sectional side view of a part of the antenna module in accordance with the first embodiment of the present invention.

FIG. 5 is a sectional end view of a part of the antenna module in accordance with the first embodiment of the present invention.

FIG. 6 is an elevational view of an antenna module in accordance with a second embodiment of the present invention.

FIG. 7 is a top view illustrating the array arrangement of the conductive clamps at the printed circuit board in accordance with the present invention.

### DETAILED DESCRIPTION OF THE INVENTION

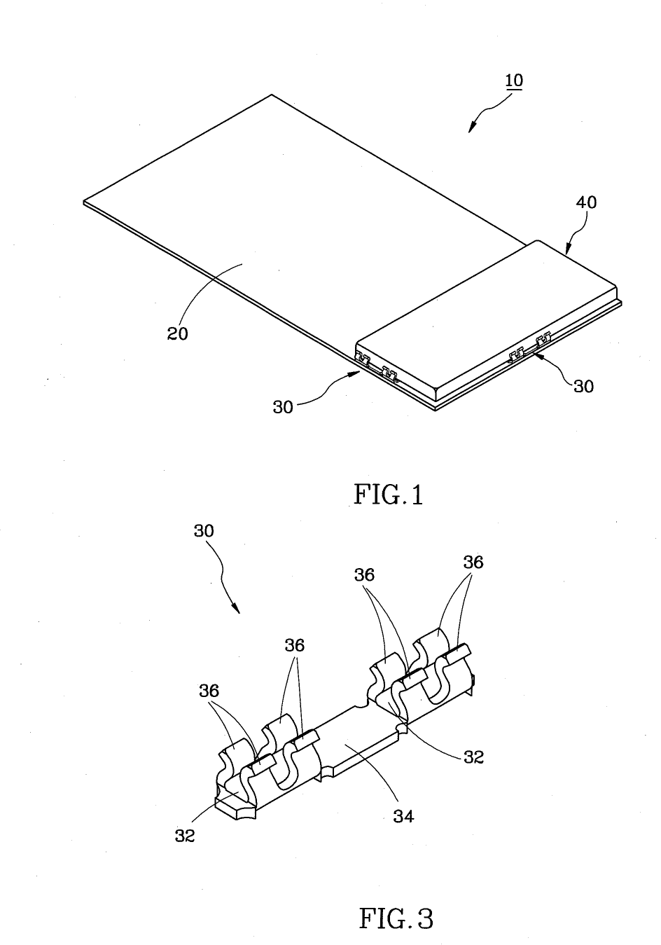

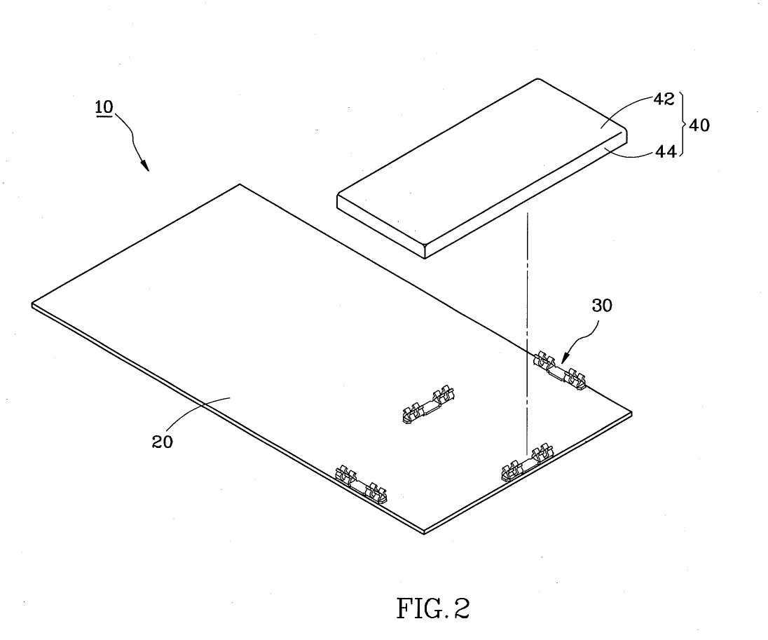

Referring to FIGS. 1 and 2, an antenna module in accordance with a first embodiment of the present invention is shown. The antenna module 10 comprises a printed circuit board 20, a plurality of conductive clamps 20, and an antenna 40. The printed circuit board 20 is of the known art, and therefore, no further detailed description in this regard is necessary.

Referring to FIG. 3, each conductive clamp 20 comprises two base portions 32, a handle 34 connected between the two base portions 32, and two pairs of elastic clamping arms 36 bilaterally symmetrically extended from two opposite lateral sides of each of the two base portions 32 in direction away from the printed circuit board 20. When bonding the conductive clamps 20 to the printed circuit board 20, use a mechanical arm to pick up the handle 34 of each conductive clamp 30, and then bond the base portions 32 and handle 34 of each conductive clamp 30 to the surface of the printed circuit board 20 by SMT (surface mount technology). Further, it is to be noted that the number of the base portions 32 of each conductive clamp 30 is not to be limited to 2. Alternatively, each conductive clamp 30 can be configured to provide one base portion only. In this case, the aforesaid handle 34 is not necessary. Further, the number of the elastic clamping arms 36 of each conductive clamp 30 is not limited to the aforesaid design. For example, each conductive clamp 30 can be configured to provide only one single pair of elastic clamping arms 36 at each base portion 32.

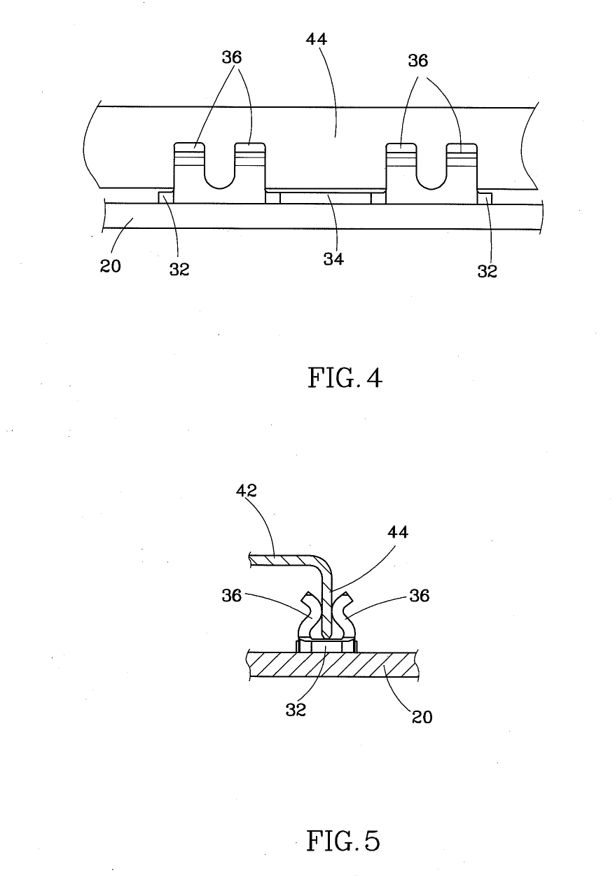

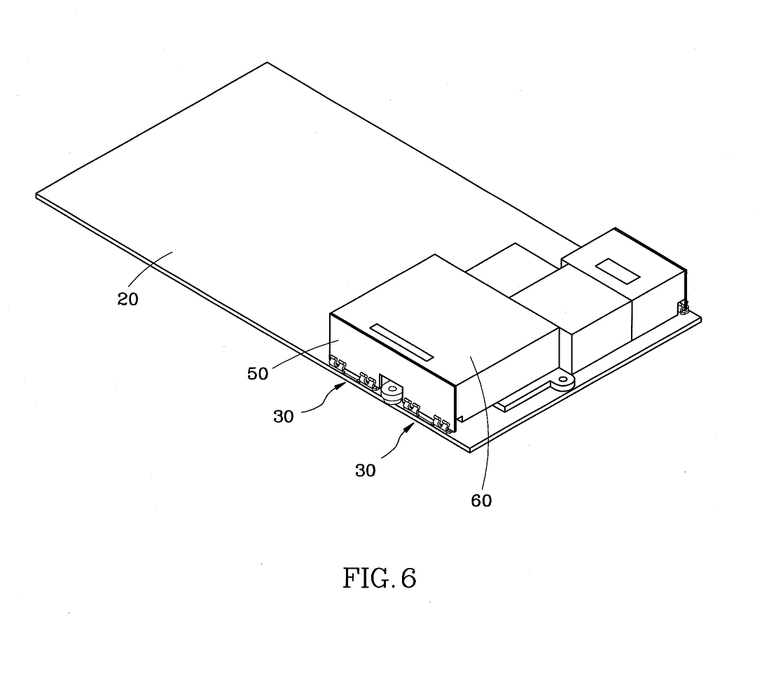

Referring to FIGS. 4 and 5 and FIG. 2 again, the antenna 40 in this embodiment is shaped like a cap member, comprising a top wall 42, and a peripheral wall 44 extended from the border of the top wall 42 toward the printed circuit board 20 and engaged in between the elastic clamping arms 36 between the two opposite lateral sides of each of the base portions 32 to become electrically conducted to the printed circuit board 30 by the conductive clamps 30. To prohibit the antenna 40 from being moved relative to the printed circuit board 20 accidentally by an external force, the conductive clamps 30 are preferably arranged at the printed circuit board 20 around the four sides of the antenna 40. However, this arrangement is not a limitation. Any person skilled in the art can adjust the number and/or mounting locations of the conductive clamps 30 subject to actual requirements. Further, in order to enhance the performance of the antenna 40, the surface area of the printed circuit board 20 beneath the antenna 40 should be kept clean without any copper wires.

As stated above, the antenna module 10 uses multiple conductive clamps 30 to secure the antenna 40 to the Printed circuit board 20. Further, one conductive clamp 30 is used as an signal feed-in point of the antenna. Subject to the designed antenna configuration, one or two conductive clamps 30 can be selected as antenna signal grounding point while the other conductive clamps 30 are used to secure the antenna 40 in position. Thus, in addition to the advantages of excellent positioning effect and ease of installation, the antenna module 10 eliminates the need of installing female screws in the printed circuit board 20, avoiding printed circuit board breaking due to installation of female screws. Further, the conductive clamps 30 have the characteristics of simple structure and small size, effectively saving the surface space of the printed circuit board 20 and enhancing circuit design flexibility.

The design of the antenna is not limited to the aforesaid cap member-shaped configuration. In a second embodiment of the present invention, as shown in FIG. 6, the antenna, referenced by 50, is shaped like a flat plate. According to this second embodiment, the antenna module further comprises a support member 60 to enhance positioning stability of the antenna 50. During installation, the flat antenna 50 is fixedly mounted at one side of the support member 60, and then inserted in between the elastic clamping arms 36 at two opposite lateral sides of each conductive clamp 30. Thus, the antenna 30 is electrically conducted to the printed circuit board 30 by the conductive clamps 30. Of course, the multiple conductive clamps 30 can be arranged on the printed circuit board 20 around the support member 60 subject to the consideration of antenna positioning stability and circuit layout design.

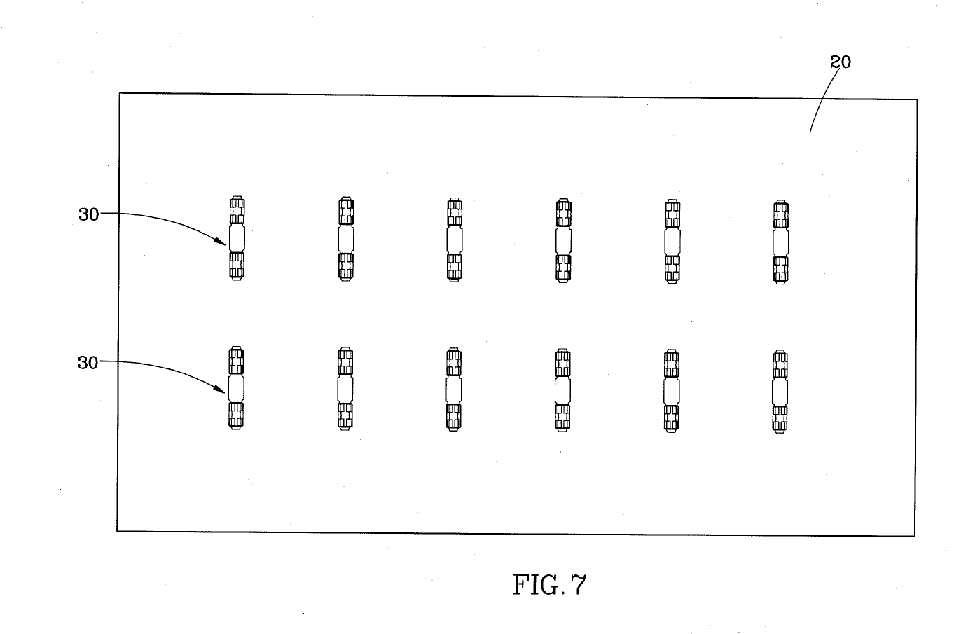

Further, it is to be noted that the conductive clamps 30 can be arranged on the printed circuit board 20 in an array arrangement, as shown in FIG. 7. Subject to this array design, different sizes of antennas can be selectively mounted at the printed circuit board 20, or, two antennas can be simultaneously mounted at the printed circuit board 20.

Although a particular embodiment of the invention has been described in detail for purposes of illustration, various modifications and enhancements may be made without departing from the spirit and scope of the invention. Accordingly, the invention is not to be limited except as by the appended claims.

What is claimed is:

1. An antenna module, comprising:
a printed circuit board;
a plurality of conductive clamps, each said conductive clamp comprising at least one base portion bonded to said printed circuit board and at least two elastic clamping arms extended from two opposite lateral sides of each said base portion in a direction away from said printed circuit board; and
an antenna detachably inserted in between the elastic clamping arms at the two opposite lateral sides of each said conductive clamp to be electrically conducted to said printed circuit board by said conductive clamps.

2. The antenna module as claimed in claim 1, wherein said antenna is shaped like a cap member comprising a top wall and a peripheral wall extended from the border of said top wall and inserted in between the elastic clamping arms at the two opposite lateral sides of each said conductive clamp.

3. The antenna module as claimed in claim 2, wherein said conductive clamps are arranged at said printed circuit board around said antenna.

4. The antenna module as claimed in claim 1, further comprising a support member mounted at said printed circuit board, wherein said antenna is shaped like a flat plate and fixedly mounted at one side of said support member and inserted in between the elastic clamping arms at the two opposite lateral sides of each said conductive clamp.

5. The antenna module as claimed in claim 1, wherein each said conductive clamp comprises two said base portions, a handle connected between the two base portions of the respective said conductive clamp, and said elastic clamping arms respectively extended from two opposite lateral sides of each said base portion of the respective said conductive clamp.

6. The antenna module as claimed in claim 5, wherein the base portions and handle of each said conductive clamp are bonded to said printed circuit board by surface mount technology.

7. The antenna module as claimed in claim 1, wherein each base portion of each said conductive clamp is bonded to said printed circuit board by surface mount technology.

8. The antenna module as claimed in claim 1, wherein said conductive clamps are arranged in an array on said printed circuit board.
